(19) United States
(12) Patent Application Publication
(10) Pub. No.: US 2006/0110980 A1
(43) Pub. Date: May 25, 2006

(54) Electrical connector with improved structure

(75) Inventors: Chang Hsin Hsu, Tu-Chen (TW); Ji-En Long, Kunsan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/166,672

(22) Filed: Jun. 23, 2005

(30) Foreign Application Priority Data
Nov. 23, 2004 (CN) 200420109517.6

(51) Int. Cl. H01R 13/648

(52) U.S. Cl. 439/607

(57) ABSTRACT

An electrical connector includes an insulative housing (1), a first and a second signal contacts (2, 3), both of which are partially received in the insulative housing (1), a shell (4) enclosing the insulative housing (1) and a grounding contact (5). The first signal contact (2) has a first elongated base portion (21) extending in a length direction of the insulative housing (1), a first connecting portion (22) extending upwardly from one end of the first elongated base portion (21), a second connecting portion (24) extending downwardly from the other end of the first elongated base portion (21), a first and a second contacting portions (23, 25) formed at an end of the first and second connecting portions (22, 24), respectively. The signal contacts (2, 3) abut against the mating components of a circuit board, thereby realizing the convenient replacement of the electrical connector.

### BACKGROUND OF THE INVENTION

1. Field of the Invention

The present invention generally relates to an electrical connector and, more particularly, to a connector used in a handy device such as mobile phones, PDAs (Personal Digital Assistance) or the like. This application relates to a contemporaneously filed application having the same title, the same applicants and the same assignee with the instant application.

2. Description of the Prior Art

An electrical product such as a mobile phone, a PDA or the like is required to be made as compactly as possible, therefore, electrical connectors used in above devices are also strongly required to be made in extremely compact designs by minimizing outer dimensions thereof. Such an electrical connector usually comprises different types of contacts, including signal contacts and grounding contacts received in an insulative housing thereof. However, with the pin count number of the contacts increasing, the insulative housing must have a corresponding increased dimension. Such large-dimension connector is space-consuming without doubt and is out of current minimizing trend. In addition, a high demand for connectors used in handy devices is convenient replacement. However, the conventional means of connecting the connectors with a corresponding element, such as a printed circuit board is welding. In this case, it is inconvenient to remove the electrical connector from the circuit board for diagnosis or replacement. Therefore, how to design an electrical connector with characters of both space saving and convenient replacement is needed to be settled urgently.

### BRIEF SUMMARY OF THE INVENTION

It is an object of the present invention to provide an electrical connector, which has a compact structure and can be replaced conveniently.

In order to achieve the above-mentioned object, an electrical connector in accordance with the present invention comprises an insulative housing, a first signal contact and a second signal contact, both of which are partially received in the insulative housing, a shell enclosing the insulative housing and a grounding contact projects from the shell. The first signal contact has a first elongated base portion extending in a length direction of the insulative housing, a first connecting portion extending upwardly from one end of the first elongated base portion, a second connecting portion extending downwardly from the other end of the first elongated base portion, a first contacting portion and a second contacting portion formed at an end of the first and second connecting portion, respectively. The configuration of the second signal contact is substantially similar to that of the first signal contact. The grounding contact and the signal contacts are arranged as much compact as possible, all of which abut against the mating components of the circuit board.

Additional novel features and advantages of the present invention will become apparent by reference to the following detailed description when taken in conjunction with the accompanying drawings.

### BRIEF DESCRIPTION OF THE DRAWINGS

FIG. 1 is a front, perspective view of an electrical connector in accordance with the present invention;

FIG. 2 is a bottom, perspective view of the electrical connector in accordance with the present invention;

FIG. 3 is an exploded, perspective view of FIG. 1;

FIG. 4 is a partially assembled view of FIG. 3;

FIG. 5 is a perspective view of a shell of the electrical connector; and

FIG. 6 is a view similar to FIG. 5, but taken from another aspect.

### DETAILED DESCRIPTION OF THE INVENTION

Reference will now be made in detail to a preferred embodiment of the present invention.

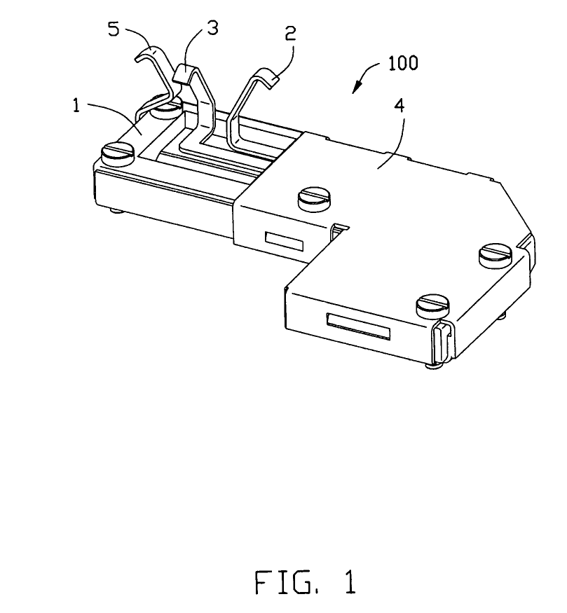

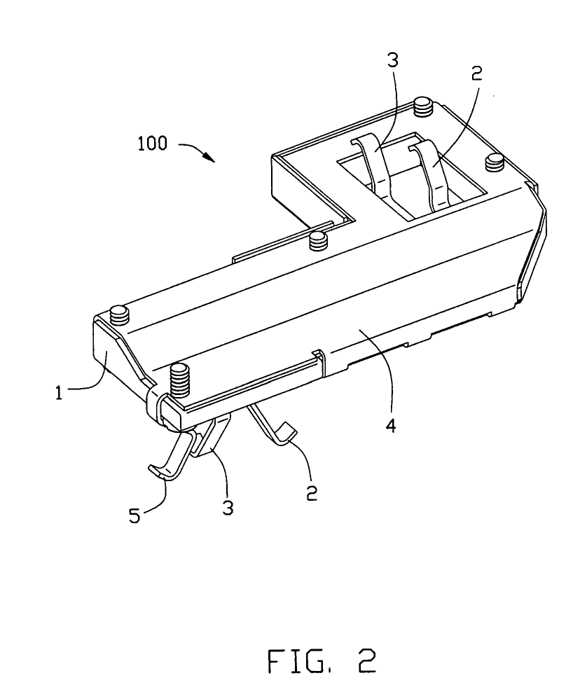

Referring to FIG. 1 and FIG. 2, an electrical connector 100 is configured in a J-shape and comprises an insulative housing 1, a first and a second signal contacts 2, 3 received in the insulative housing 1, a conductive shell 4 enclosing the insulative housing 1 and a grounding contact 5. The shell 4 is fixed to the insulative housing 1 by way of bolts.

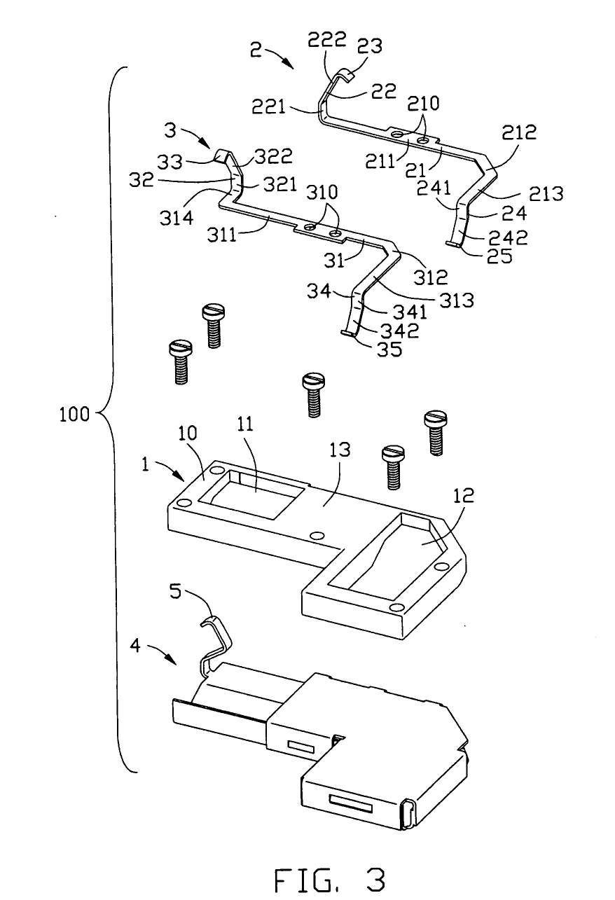

As shown in FIG. 3, the first signal contact 2 is stamped and configured from a metal sheet and comprises a first elongated base portion 21, a first and a second connecting portions 22, 24 and a first and a second contacting portions 23, 25. The first elongated base portion 21 has a first body section 211, a first inclined section 212 extending from the body section 211 at an angle of approximate 45 degrees with respect to the extending direction of the first body section 211 and a first upright section 213 extending from the first inclined section 212 at an angle of approximate 45 degrees with respect to the extending direction of the first inclined section 212. There are two holes 210 positioned in the first body section 211 of the first elongated base portion 21 in order to prevent the movement of the first signal contact 2 when the contact 2 is insert molded in the insulative housing 1. The first connecting portion 22 includes a first connecting section 221 extending upwardly and vertically from one end of the first base portion 21 and an inclined first spring arm 222 projecting upwardly and obliquely from the first connecting section 221. The angle formed between the first connecting section 221 and the first spring arm 222 is bigger than 90 degrees. The first contacting portion 23 is curved from the free end of the first spring arm 222 approximately toward the first elongated base portion 21. The second connecting portion 24 extends downwardly from the first elongated base portion 21 and has the same size and configuration as that of the first connecting portion 22. The second connecting portion 24 comprises a second connecting section 241 extending downwardly from the first upright section 213 and an inclined second spring arm 242 projecting downwardly obliquely from the second connecting section 241. The second contacting portion 25 and the first contacting portion 23 are of the same size and configuration. The second contacting portion 25 is curved from the second spring arm 242 towards the plane in which the first elongated base portion 21 is located.

The second signal contact 3 includes a second elongated base portion 31, a first and a second bending portions 32, 34 respectively coupled to opposite ends of the second elongated base portion 31 and a first and a second touching portions 33, 35 connected respectively to the first and second bending portions 32, 34. Each bending portion 32, 34 comprise a connecting arm 321, 341 and a spring parts 322, 342, respectively. Each portion of the second signal contact 3 has substantially the same shape as that of the first signal contact 2 except the second elongated base portion 31. So other structures will not be described in detail here. The second elongated base portion 31 comprises an additional upright section 314 besides a second body section 311 with other two holes 310, a second inclined section 312 and a second upright section 313, which are the same shape as corresponding sections of the first elongated base portion 21. The additional upright section 314 extends perpendicularly from one end of the second body section 311 and the first touching portion 33 projects from an end of the additional upright section 314, thus, the vertical projection of the first bending portion 32 and touching portion 33 at a plane of the second base portion 31 is perpendicular to the vertical projection of the first connecting portion 22 and the first contacting portion 23 at the same plane aforementioned. The special structure of the signal contacts 2, 3, particularly the structures of the first and second contacting portions 23, 25, and touching portions 33, 35 make themselves press against corresponding components of the circuit board effectively and expediently thereby realizing convenient replacement of the connector 100.

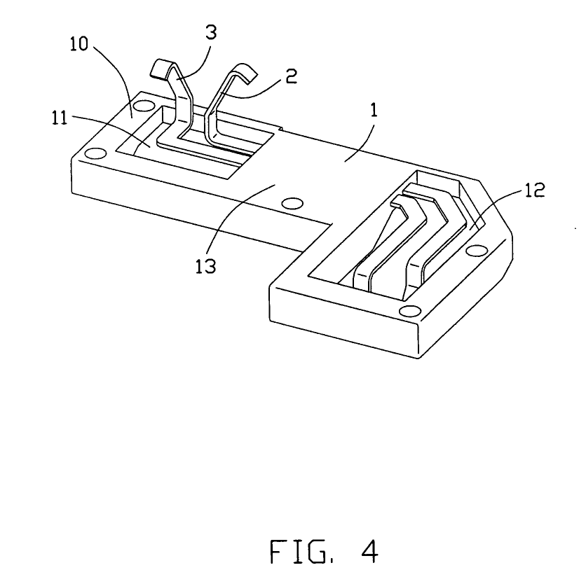

Referring to FIG. 3 and FIG. 4, the insulative housing 1 configured as a laid-down J shape comprises a frame 10 and a base body 13 positioned in the middle of the frame 10. The frame 10 and the base body 13 cooperate to define a first space 11 and a second space 12. The first body section 211 of the first elongated base portion 21 and the second body section 311 of the second elongated base portion 31 are insert molded into the base body 13 of the insulative housing 1. The first connecting section 221 and the first connecting arm 321 corresponding to the first and second signal contacts 2, 3 are received in the first space 11, while the first spring arm 222 and the first spring part 322 project out of the first space 11, thus, the first contacting portion 23 and touching portion 33 expose themselves to an outer space. The second connecting section 241 and the second connecting arm 341 corresponding to the first and second signal contacts 2, 3 are received in the second space 12, while the second spring arms 242 and the second spring part 342 project out of the second space 12, thus, the second contacting portion 23 and the second touching portion 33 expose themselves to the outer space. The inclined sections 212, 312 and the upright sections 213, 313 are all received in the second space 12. The first and second elongated base portions 21, 31, the second connecting portion 24 and the second bending portion 34, and the second contacting portion 25 and the second touching portion 35 are parallel to each other, respectively.

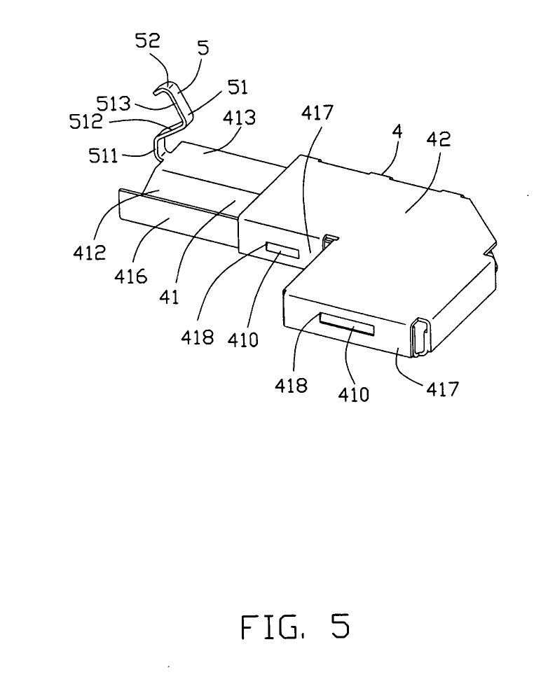

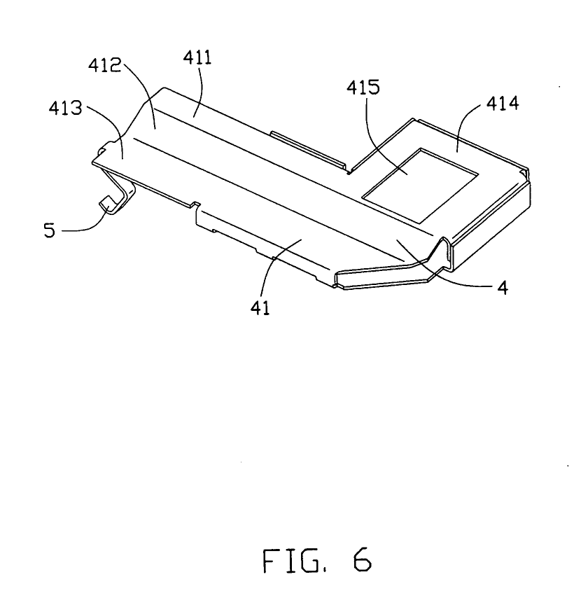

As shown in FIG. 5 and FIG. 6, the shell 4 is configured and stamped based on the structure of the insulative housing 1 and comprises a lower plate 41 and an upper plate 42. The lower plate 41 comprises a three-layer piece portion and a rectangle frame 414. The three-layer piece portion comprises a first metal layer 411, a second metal layer 412 and a third metal layer 413. The first and third metal layers 411, 413 are parallel to each other. The second metal layer 412 is coupled to the first and third metal layers 411, 413 both at obtuse angles. The rectangle frame 414 defines a rectangle hollow space 415 for protrusion of the signal contacts 2, 3. Some projections 410 are formed on sidewalls 416 of the lower plate 41 as well as some slots 418 corresponding to the projections 410 are positioned in the sidewalls 417 of the upper plate 42. The upper plate 42 cooperates with the lower plate 41 by means of the projections 410 interferentially insetting into the slots 418.

From FIG. 5 and FIG. 6, it is apparent that a grounding contact 5 extends from a front edge of the low plate 41 of the shell 4. The grounding contact 5 comprises a bending arm 51 and a tangent portion 52. The bending arm 51 contains an upright arm 511 vertically and upwardly extending from the front edge of the third metal layer 413 of the lower plate 41, a first oblique section 512 extends inwardly and upwardly from the upright arm 511 at an angle of approximate 45 degrees and a second oblique section 513 extends outwardly from the first oblique section 512 at acute angle. The tangent portion 52 extends outwardly and downwardly from the bending arm 51 and has the same shape as those of the contacting portions 23, 25 and the touching portions 33, 35. Specially referring to FIG. 1, the first contacting portion 23 and touching portion 33 and the tangent portion 52 are of uniform height so as to locate on the same plane and abut against a mating printed circuit board (not shown) easily and perfectly. Moreover, the first connecting portion 22, the first bending portion 32 and the bending arm 51, the first contacting portion 23, the first touching portion 33 and the tangent portion 52 are arranged in a predetermined direction and close to each other for space saving.

While the foregoing description includes details which will enable those skilled in the art to practice the invention, it should be recognized that the description is illustrative in nature and that many modifications and variations thereof will be apparent to those skilled in the art having the benefit of these teachings. It is accordingly intended that the invention herein be defined solely by the claims appended hereto and that the claims be interpreted as broadly as permitted by the prior art.

What is claimed is:

1. An electrical connector comprises:
an insulative housing;
a first signal contact partially received in the insulative housing and having a first elongated base portion extending in a length direction of the insulative housing, a first connecting portion extending upwardly from one end of the first elongated base portion, a second connecting portion extending downwardly from the other end of the first elongated base portion, a first contacting portion and a second contacting portion formed at an end of the first and second connecting portion, respectively;
a shell enclosing the insulative housing.

2. The electrical connector as claimed in claim 1, wherein the first and second contacting portions of the first signal contact is configured as curve shape so as to press against a mating components thereof perfectly.

3. The electrical connector as claimed in claim 1, wherein the first and second connecting portions extend from the first elongated base portion in different directions.

4. The electrical connector as claimed in claim 1, wherein the first elongated base portion is insert molded in the insulative housing.

5. The electrical connector as claimed in claim 1, wherein the first elongated base portion has a body section, an inclined section extending from an end of the body section and an upright section extending from an end of the inclined portion.

6. The electrical connector as claimed in claim 1, wherein the first connecting portion comprises a first connecting section and a first spring arm, and the second connecting portion comprises a second connecting section and a second spring arm, and wherein each connecting section presents perpendicularly at an end of the first elongated base portion, and each spring arm presents at an end of said respective connecting section at obtuse angle.

7. The electrical connector as claimed in claim 6, wherein said insulative housing defines a first space and a second space, and wherein the first spring arm and the first contacting portion of the first signal contact protrude out of the first space, and the second spring arm and the second contacting portion protrude out of the second space.

8. The electrical connector as claimed in claim 1, wherein the electrical connector further comprises a second signal contact parallel to the first signal contact.

9. The electrical connector as claimed in claim 8, wherein the second signal contact is insert molded in the insulative housing.

10. The electrical connector as claimed in claim 8, wherein the second signal contact has the same configuration except a second elongated base portion thereof, the second elongated base portion comprising an additional upright portion extending from an end of the second elongate base portion.

11. The electrical connector as claimed in claim 1, wherein the electrical connector further comprises a second signal contact having a second elongated base portion, a first bending portion extending from an end of the second elongated base portion and a second bending portion extending from the other end of the second elongated base portion.

12. The electrical connector as claimed in claim 11, wherein the vertical projection of the first bending portion of the second signal contact at the plane of the second elongated base portion is perpendicular to the vertical projection of the first connecting portion of the first signal contact at the same plane.

13. The electrical connector as claimed in claim 1, wherein the insulative housing is formed in a J-shape and comprises a frame and a base body positioned in the middle of the frame, the first elongated base portion of the first signal contact being insert molded in the base body.

14. The electrical connector as claimed in claim 1, wherein the shell has a lower plate and an upper plate, and wherein the lower plate has hollow space for protrusion of the second contacting portion of the first signal contact, and the upper plate covers the insulative housing partially for protrusion of the first contacting portion of the first signal contact.

15. The electrical connector as claimed in claim 14, wherein the lower plate has some projections and the upper plate has respective slots, and wherein the lower plate of the shell cooperates with the upper plate by means of the projections interferentially insetting into the slots.

16. The electrical connector as claimed in claim 1, wherein the electrical connector further comprises a grounding contact extending from the shell.

17. The electrical connector as claimed in claim 16, wherein the grounding contact is adjacent to the first signal contact.

18. The electrical connector as claimed in claim 16, wherein the grounding contact has a tangent portion arranged adjacent to the first contacting portion of the first signal contact and having the same configuration as the first contacting portion.

19. An electrical connector comprising:
an insulative housing defining, from a top view, an L-shaped configuration including a long section and a short section perpendicular to each other; the long section defining a first opening and the short section defining a second opening;
a metallic shield essentially having the similar configuration with the housing and enclosing said housing, said shield defining an upward opening essentially vertically aligned with the first opening, and a downward opening essentially vertically aligned with the second opening;
at least one contact secured in the housing and having a first contact portion extending upwardly from the first opening and the corresponding upward opening beyond a top face of said shield, and a second contact portion extending downwardly from the second opening and the corresponding downward opening beyond a bottom face of the shield so that said first contact portion and said second contact portion are adapted to be engaged with corresponding mating components which are respectively located above and below the connector.

20. The connector as claimed in claim 19, wherein at least one bolt extends through the associated shield and housing with a threaded end extending beyond one of the top and bottom faces of the shield for securing to the mating component adjacent to said one of the top and bottom faces of the shield.

21. An electrical connector comprising:
an insulative housing defining, from a top view, an L-shaped configuration including a long section and a short section perpendicular to each other;
a first opening defined in the long section and a second opening defined in the short section; and
first and second contacts disposed in the housing, each of said first and second contacts defining an upper contact portion extending upwardly from the first opening above a top face of the housing, and a lower contact portion extending downwardly from the second opening below a bottom face of the housing, wherein at least one bolt extends through the housing with a threaded end extending beyond of the top and bottom faces of the housing for securing to a mating component thereabouts.

22. The connector as claimed in claim 21, wherein from the top view, the upper contact portions of said first and second contacts extend angular to each other while the lower contact portions of the first and second contacts extend parallel to each other.
